(19) United States
(12) Patent Application Publication
(10) Pub. No.: US 2024/0129097 A1
(43) Pub. Date: Apr. 18, 2024

(54) TRANSMITTER FOR ENHANCING CSI REPORTING IN MULTI-TRP SCENARIO

(71) Applicant: JRD COMMUNICATION (SHENZHEN) LTD., Shenzhen, Guangdong (CN)

(72) Inventors: Tian LI, Shenzhen, Guangdong (CN); Jia SHENG, Shenzhen, Guangdong (CN)

(73) Assignee: JRD COMMUNICATION (SHENZHEN) LTD., Shenzhen, Guangdong (CN)

(21) Appl. No.: 18/546,278

(22) PCT Filed: Mar. 23, 2021
(86) PCT No.: PCT/CN2021/082442

§ 371 Date: Aug. 14, 2023

(51) Int. Cl. H04L 5/00; H04B 7/024

(52) U.S. Cl. CPC H04L 5/0053; H04B 7/024; H04L 5/0035

(57) ABSTRACT

Disclosed is a transmitter for enhancing CSI reporting in multi-TRP/panel scenario. Several solutions are proposed to support A-CSI/SP-CSI reporting on PUSCH with repetition, which include activation and deactivation of CSI reporting, transmission occasion of SP-CSI reporting, and CSI reporting on PUSCH with repetition w/wo UL data. With the improvements, the support for A-CSI/SP-CSI reporting on PUSCH with repetition in multi-TRP/panel scenario is greatly enhanced.

### TECHNICAL FIELD

The present disclosure relates to the field of wireless communication systems, and more particularly, to a transmitter for enhancing channel state information (CSI) reporting in multiple transmission-reception point (multi-TRP)/panel scenario.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base station, and an interface to a core network (CN) which provides overall network control. The RAN and CN each conducts respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a next generation Node B called gNodeB (gNB).

The 5G standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

A base station (BS) refers to a network central unit in the NR that is used to control one or multiple TRPs associated with one or multiple cells. ABS could be referred to as, eNB, NodeB, or gNodeB (also called gNB). A TRP is a transmission and reception point that provides network coverage and directly communicates with UEs, for example. A cell is composed of one or multiple associated TRPs, i.e. the coverage of the cell is a superset of the coverage of all the individual TRP(s) associated with the cell. One cell is controlled by one BS. A cell can also be referred to as a TRP group (TRPG).

To exploit multiple path propagation, Multiple Input Multiple Output (MIMO) is a technique for multiplying the capacity of a radio link using multiple transmitting and receiving antennas. By deploying multiple antennas at the transmitter and the receiver, MIMO refers to a practical technique for sending and receiving more than one data signal simultaneously over a same radio channel (for large space) via multipath propagation, which improves the performance of spectral efficiency greatly.

As shown in FIG. 1, for a UE operating in multi-TRP/panel transmission in NR, Physical Uplink Shared Channel (PUSCH) repetition can be scheduled in different transmission occasions toward different TRPs so that UE has multiple chances to perform PUSCH transmission. PUSCH repetition targeting towards different TRPs can avoid possible blockage between any TRP and the UE. As a result, PUSCH repetition not only enhance the reliability but also improve the coverage.

Regarding the deployment of multi-TRP/panel, single-DCI based multi-TRP PUSCH repetition and multiple-DCI based multi-TRP PUSCH repetition are designed. Single-DCI based multi-TRP PUSCH repetition is beneficial when different TRPs are connected by ideal backhaul, while multiple-DCI based multi-TRP PUSCH repetition is beneficial when different TRPs are connected by non-ideal backhaul.

In Rel-15/16, PUSCH repetition type A and type B have been specified. For PUSCH repetition type A, different repetitions of PUSCH are in different slots, which have the same length and starting symbol. For PUSCH repetition type B, due to the crossing slot boundary or invalid symbols, a nominal repetition is divided into multiple actual repetitions. For PUSCH repetition type A, the number of repetitions is determined by the higher layer parameter numberOfRepetitions-r16 and pusch-AggregationFactor. For PUSCH repetition Type B, the number of nominal repetitions is determined by the higher layer parameter numberOfRepetitions-r16. Regarding single-DCI based multi-TRP PUSCH repetition type A and type B, a single DCI schedules all the PUSCH repetitions.

A UE shall perform aperiodic CSI reporting using PUSCH when the UE successfully decodes a DCI format (e.g. DCI format 0_1 or DCI format 0_2) which triggers an aperiodic CSI trigger state. A UE shall perform semi-persistent CSI reporting on the PUSCH when the UE successfully decodes a DCI format (e.g. DCI format 0_1 or DCI format 0_2) which activates a SP-CSI trigger state. For SP-CSI reporting on PUSCH, the DCI format (e.g. DCI format 0_1 or DCI format 0_2) contains a CSI request field which indicates the SP-CSI trigger state to activate or deactivate. A-CSI reporting on PUSCH can be multiplexed with uplink data on PUSCH. A-CSI and SP-CSI reporting on PUSCH can be performed without any multiplexing with uplink data from the UE.

### PROBLEM FORMULATION

For multi-TRP PDCCH repetition scheme, the two linked PDCCH candidates are transmitted from two different TRPs and have different PDCCH monitoring occasions, i.e., the two linked PDCCH candidates are repeated PDCCHs. If the DCIs of the repeated PDCCHs are used to schedule the same A-CSI/SP-C SI reporting on PUSCH, there may be ambiguity about the reference slot for activation of A-CSI/SP-C SI reporting and deactivation of SP-CSI reporting. This ambiguity issue needs to be solved.

The transmission occasion of the n-th nominal repetition (e.g. type A and type B) may be different from the transmission occasion of the n-th SP-CSI report on PUSCH without repetition. How to determine the transmission occasion of SP-CSI reporting on PUSCH with repetition is important.

In Rel-16, when A-CSI/SP-CSI is requested in the DCI scheduling PUSCH repetitions, the A-CSI/SP-CSI is multiplexed only on the first PUSCH repetition for PUSCH repetition type A and PUSCH repetition type B. However, in Rel-17, PUSCH repetitions with two beams are deployed in multi-TRP scenario, A-CSI/SP-CSI transmitted on at least two PUSCH repetitions with different beams can benefit from the increased diversity and reliability. It is important as to how to transmit the A-CSI/SP-CSI on more PUSCH with repetitions.

### RELATED ARTS

In RANI #104e meeting, for the repetition scheme, a reference PDCCH candidate is defined to resolve the ambiguities and the detailed agreement is shown as follows:

### Agreement:

For Option 2, at least for the following purposes, a reference PDCCH candidate is defined as the candidate that ends later in time among the two linked PDCCH candidates in the time domain:
To determine the scheduling offset to identify whether a default beam should be used for PDSCH / CSI-RS reception.
To extend the definition of in-order for PDCCH-PDSCH and PDCCH-PUSCH, i.e., PDCCH ending symbol is the last symbol of the reference PDCCH candidate in at least the following restrictions in 38.214.
   For any two HARQ process IDs in a given scheduled cell, if the UE is scheduled to start receiving a first PDSCH starting in symbol j by a PDCCH ending in symbol I, the UE is not expected to be scheduled to receive a PDSCH starting earlier than the end of the first PDSCH with a PDCCH that ends later than symbol i.
   For any two HARQ process IDs in a given scheduled cell, if the UE is scheduled to start a first PUSCH transmission starting in symbol j by a PDCCH ending in symbol I, the UE is not expected to be scheduled to transmit a PUSCH starting earlier than the end of the first PUSCH by a PDCCH that ends later than symbol i.
For PUSCH preparation time (N2) and CSI computation time (Z): Last symbol of the PDCCH is based on the last symbol of the reference PDCCH candidate.
FFS: If inter-slot PDCCH repetition is supported, for slot offset for scheduling the same PDSCH/PUSCH/CSI-RS/SRS: The slot of the reference PDCCH candidate is used as the reference slot.

In RAN1 #104e meeting, the A-CSI is supported to be multiplexed on the PUSCH with repetition and supporting SP-CSI/P-CSI on PUSCH repetitions would be further studied. The detailed agreement is shown as follows:

### Agreement:

For s-DCI based multi-TRP PUSCH repetition Type A and B, if the DCI schedules A-CSI, support multiplexing A-C SI on the first PUSCH repetition corresponding to the first beam and the X-th PUSCH repetition corresponding to the second beam.
For PUSCH repetition Type A, X=1 (the first PUSCH repetition corresponding to the second beam)
For PUSCH repetition Type B, the first actual PUSCH repetition corresponding to the first beam and the X-th actual repetition corresponding to the second beam are considered,
   The UE does not expect the first actual repetition corresponding to the first beam and the X-th actual repetition corresponding to the second beam to have a single symbol duration (similar restriction as in Rel-16 NR for the single TRP case).
   The first actual repetition corresponding to the first beam and the X-th actual repetition corresponding to the second beam are expected to have the same number of symbols
   FFS: X=1 or X=the first actual repetition corresponding to the second beam that contains the same number of symbols as the first actual repetition with the first beam
FFS: Any further restrictions/enhancements needed on supporting A-C SI multiplexing on PUSCH repetitions
FFS: whether to support multiplexing SP-CSI/P-CSI on PUSCH repetitions towards multiple TRPs.

### TECHNICAL PROBLEM

For activation and deactivation of A-C SI/SP-C SI reporting, UE may be confused with the referenced PDCCH candidate. Moreover, the CSI report(s) can only be transmitted on PUSCH with one beam and cannot benefit from the increased diversity and reliability.

### TECHNICAL SOLUTION

A first aspect of the present disclosure provides a transmitter, configured to communicate in a communication system, the transmitter comprising: one or more interfaces configured to communicate with multiple transmission-reception points (multi-TRPs) within the communication system; and a circuitry configured to: activate channel state information (CSI) reporting by physical downlink control channel (PDCCH) repetition scheme, wherein a reference slot for the activating corresponds to a referenced PDCCH candidate that is defined as the candidate that starts earlier in time or that ends later in time among two linked PDCCH candidates in time domain.

A second aspect of the present disclosure provides a transmitter, configured to communicate in a communication system, the transmitter comprising: one or more interfaces configured to communicate with multiple transmission-reception points (multi-TRPs) within the communication system; and a circuitry configured to: report SP-CSI on PUSCH with repetition based on transmission occasion of PUSCH with repetition when receiving a downlink control information (DCI) that activates a SP-CSI report on PUSCH by a CSI request field on the DCI.

A third aspect of the present disclosure provides a transmitter, configured to communicate in a communication system, the transmitter comprising: one or more interfaces configured to communicate with multiple transmission-reception points (multi-TRPs) within the communication system; and a circuitry configured to: in response to transmit a transport block and A-CSI report on PUSCH repetition type B, multiplex the A-C SI report on a first actual repetition with a first beam and a first actual repetition with a second beam that has the same number of symbols as the first actual repetition with the first beam; in response to transmit a transport block and SP-CSI report on PUSCH repetition type B, multiplex the SP-CSI report on a first actual repetition with the first beam and a first actual repetition with the second beam that has the same number of symbols as the first actual repetition with the first beam; or multiplex the the SP-CSI report on a first nominal repetition corresponding to the first beam and a first nominal repetition corresponding to the second beam.

A fourth aspect of the present disclosure provides a transmitter, configured to communicate in a communication system, the transmitter comprising: one or more interfaces configured to communicate with multiple transmission-reception points (multi-TRPs) within the communication system; and a circuitry configured to: in response to transmit A-CSI/SP-CSI report without any transport block on two PUSCH repetitions and on PUSCH repetition type B, transmit the A-CSI/SP-CSI report on a first nominal repetition corresponding to a first beam and a first nominal repetition corresponding to a second beam; or transmit the A-CSI/SP-C SI report on a first actual repetition of the first nominal repetition corresponding to the first beam and a first actual repetition corresponding to the second beam that has the same number of symbols as the first actual repetition corresponding to the first beam; or transmitted the A-CSI/SP-CSI report on a first actual repetition of the first nominal repetition corresponding to the first beam and a first actual repetition corresponding to the second beam.

The disclosed transmitter may be implemented by a UE and the disclosed receiver may be implemented by a base station such as gNodeB, or by a TRP, for example. In other circumstance, the transmitter/receiver may be implemented by a base station such as gNodeB, or by a TRP, for example.

The disclosed transmitter may utilize a method that may be programmed as computer executable instructions stored in non-transitory computer readable medium. The non-transitory computer readable medium, when loaded to a computer, directs a processor of the computer to execute the disclosed method. The method may be programmed as computer program product, that causes a computer to execute the disclosed method.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

### ADVANTAGEOUS EFFECTS

In this disclosure, first of all, the UE can determine the slot for activation of A-CSI/SP-CSI reporting and deactivation of SP-CSI reporting. Secondly, the SP-CSI reporting occasion on PUSCH with repetition is determined. Thirdly, regarding A-CSI/SP-CSI reporting on PUSCH with repetition w/wo UL data, several methods are proposed to transmit A-CSI/SP-CSI on at least two PUSCH repetitions with different beams. The support for A-CSI/SP-CSI reporting on PUSCH with repetition in multi-TRP/panel scenario is greatly enhanced.

### DESCRIPTION OF DRAWINGS

In order to more clearly illustrate the embodiments of the present disclosure or related art, the following figures that will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating PUSCH repetitions in multi-TRP/panel scenario.

FIG. 2 is a schematic diagram illustrating an example of ambiguity of the reference slot.

FIG. 3 is a schematic diagram illustrating another example of ambiguity of the reference slot.

FIG. 4 is a schematic diagram illustrating an example of actual repetition on the next nominal repetition.

FIG. 5 is a schematic diagram illustrating an example of actual repetition with a larger number of symbols.

FIG. 6 is a schematic diagram illustrating an example of SP-CSI reporting on PUSCH with repetition type A.

FIG. 7 is a schematic diagram illustrating an example of actual repetition with the same number of symbols.

FIG. 8 is a schematic diagram illustrating an example of nominal repetition as the same as first actual repetition.

FIG. 9 is a schematic diagram illustrating an example of CSI reporting on more than two PUSCH repetitions.

FIG. 10 is a schematic diagram illustrating an example of SP-CSI reporting on the first nominal repetition.

FIG. 11 is a schematic diagram illustrating another example of SP-CSI reporting on the first nominal repetition.

FIG. 12 is a schematic diagram illustrating an example of A-CSI/SP-CSI transmitting on more than two PUSCH repetitions.

FIG. 13 is a block diagram of an example system for wireless communication according to an embodiment of the present disclosure.

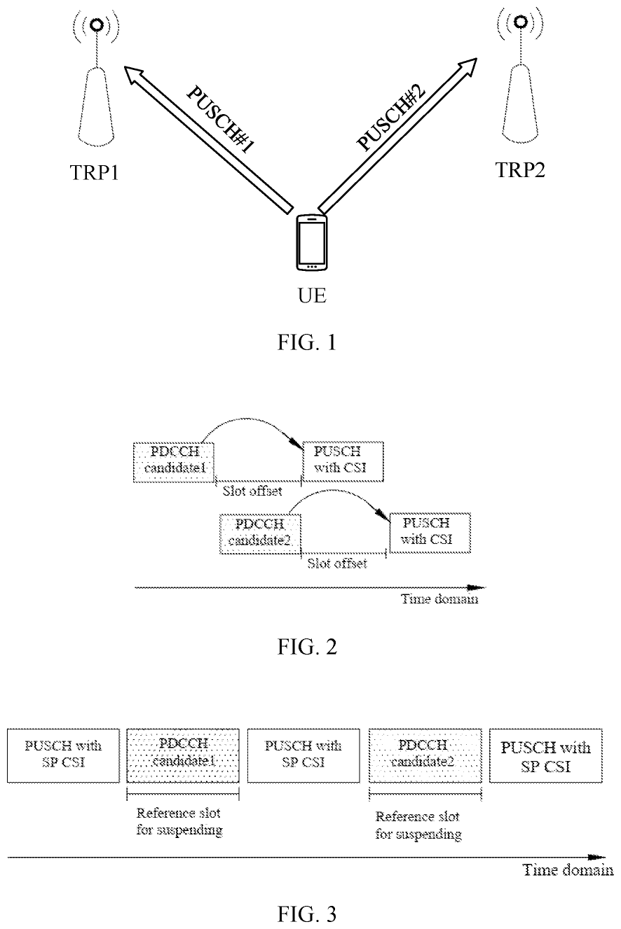

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

For easy of understanding, it is noted that in some circumstance, the term transmitter may be implemented by a UE and the term receiver may be implemented by a base station such as gNodeB, or by a TRP, for example; in other circumstance, the transmitter/receiver may be implemented by a base station such as gNodeB, or by a TRP, for example. However, this should not be taken as a limitation to interpretation of this invention.

The following abbreviations are used in the present disclosure.

3GPP Third Generation Partnership Project

A-CSI Aperiodic Channel State Information

CSI Channel State Information

DCI Downlink Control Information

gNB Generation Node B

NR New Radio

PDCCH Physical Downlink Control Channel

PDSCH Physical Downlink Shared Channel

PUCCH Physical Uplink Control Channel

PUSCH Physical Uplink Shared Channel

RAN Radio Access Network

Rel Release

SP-CSI Semi-Persistent Channel State Information

TDRA Time Domain Resource Assignment

TRP Transmission/Reception Point

UE User Equipment

UL Uplink

In Problem Formulation, it was highlighted that UE may be confused with the referenced PDCCH candidate. Moreover, without the methods to transmit A-CSI/SP-CSI on PUSCH with different beams, the CSI report(s) can only be transmitted on PUSCH with one beam and cannot benefit from the increased diversity and reliability.

This disclosure is related to the wireless communication systems operating in multiple input multiple output (MIMO) systems. More specifically, the target is the improvement of A-CSI/SP-CSI reporting on PUSCH with repetition in multiple transmission-reception point (multi-TRP)/panel scenario. The main idea of this disclosure is to provide a new design for multiple TRP/panel based transmission, through which the transmitter is allowed to support A-CSI/SP-CSI reporting on PUSCH with repetition.

In this disclosure, several solutions are proposed to support A-CSI/SP-CSI reporting on PUSCH with repetition, which include activation and deactivation of CSI reporting, transmission occasion of SP-CSI reporting, CSI reporting on PUSCH with repetition w/wo UL data. First of all, by defining the referenced PDCCH candidate, the UE can determine the slot for activation of A-CSI/SP-CSI reporting and deactivation of SP-CSI reporting. Secondly, by aligning with the transmission occasion of PUSCH with repetition, the SP-CSI reporting occasion on PUSCH with repetition is determined. Thirdly, regarding A-CSI/SP-CSI reporting on PUSCH with repetition w/wo UL data, several methods are proposed to transmit A-CSI/SP-CSI on at least two PUSCH repetitions with different beams, including A-CSI/SP-CSI reporting on nominal repetition and actual repetition, A-CSI/SP-CSI reporting on PUSCH with repetition type A and type B. Taking these methods into consideration, the support for A-CSI/SP-CSI reporting on PUSCH with repetition in multi-TRP/panel scenario is greatly enhanced.

1. Activation and deactivation of A-CSI/SP-CSI reporting

For multi-TRP PDCCH repetition scheme, the two linked PDCCH candidates are transmitted from two different TRPs and have different PDCCH monitoring occasions. In other words, for PDCCH repetition scheme, the two linked PDCCH candidates are repeated PDCCHs. For the intra-slot PDCCH repetition scheme, the repeated PDCCH is transmitted in the same slot, while for the inter-slot PDCCH repetition scheme, the repeated PDCCH is transmitted in the different slot.

The reference slot for scheduling a PUSCH is determined based on the slot that UE successfully decodes the scheduling DCI. If the DCIs of the repeated PDCCHs are used to schedule the same A-CSI/SP-CSI reporting on PUSCH, there may be ambiguity about the reference slot for activation of A-CSI/SP-CSI reporting and deactivation of SP-CSI reporting. In this section, several methods are proposed to resolve the ambiguity issue.

1. 1 Activation of A-CSI/SP-CSI reporting

If UE reports CSI on PUSCH with multiplexing with uplink data, the TDRA field of the DCI provides a row index to an allocated table and the slot offset value of the PUSCH is determined by the row index. If UE reports CSI on PUSCH without any multiplexing with uplink data, the slot offset value of the PUSCH is determined by the corresponding list entries of the higher layer parameter (e.g. reportSlotOffsetListDCI-0-2, reportSlotOffsetListDCI-0-1 and reportSlotOffsetList).

Considering that the repeated PDCCHs have the same coded bits, the slot offset values of the DCIs of the repeated PDCCHs are the same. If the DCIs of the repeated PDCCHs are used to schedule the same A-CSI/SP-CSI reporting on PUSCH, there may be two transmission occasions for CSI reporting especially in inter-slot PDCCH repetition, as is shown in FIG. 2. However, it is not the intention of applying PDCCH repetition scheme. In this section, several methods are proposed to determine the reference slot.

(1) Reference slot of the first PDCCH candidate

For PDCCH repetition scheme, if the DCIs of the repeated PDCCHs are used to schedule the same A-CSI/SP-CSI reporting on PUSCH, using the PDCCH candidate that starts earlier in time can reduce the latency. Hence, it is proposed that a referenced PDCCH candidate is defined as the candidate that starts earlier in time among the two linked PDCCH candidates in the time domain. For example, if the slot of the first PDCCH candidate that starts earlier in time is slot n and the slot offset value is K, the slot that A-CSI reports on the PUSCH is slot (n+K) and SP-CSI firstly reports on the PUSCH is slot (n+K).

(2) Reference slot of the second PDCCH candidate

For PDCCH repetition scheme, if the DCIs of the repeated PDCCHs are used to schedule the same A-CSI/SP-CSI reporting on PUSCH, using the PDCCH candidate that ends later in time can increase the preparation time for CSI reporting. Hence, it is proposed that a referenced PDCCH candidate is defined as the candidate that ends later in time among the two linked PDCCH candidates in the time domain. For example, if the slot of the last PDCCH candidate that ends later in time is slot n and the slot offset value is K, the slot that A-CSI reports on the PUSCH is slot (n+K) and SP-CSI firstly reports on the PUSCH is slot (n+K).

1. 2 Deactivation of SP-CSI reporting

If SP-CSI reporting on PUSCH is activated, UE would continue to report SP-CSI on PUSCH until UE successfully decodes the DCI that indicates the release of SP-CSI transmission on PUSCH. For multi-TRP PDCCH repetition scheme, if the repeated PDCCHs carry the same DCI that indicates the release of SP-CSI transmission on PUSCH, there may be two transmission occasions for the release of SP-CSI transmission especially in inter-slot PDCCH repetition, as is shown in FIG. 3. In this section, several methods are proposed to determine the reference slot for the release of SP-CSI transmission on PUSCH.

(1) Suspending the SP-CSI transmission without any indication

If multi-TRP PUSCH repetition is configured and SP-CSI is reported on PUSCH, it is proposed that when UE completes all the repetitions, UE suspends the SP-CSI transmission on PUSCH without any indication of suspending the SP-CSI transmission. This is a simple way to suspend the SP-CSI transmission on PUSCH.

(2) Reference slot of the first PDCCH candidate

For PDCCH repetition scheme, if the DCIs of the repeated PDCCHs are used to release the SP-CSI transmission on PUSCH, using the PDCCH candidate that starts earlier in time can suspend the SP CSI transmission as soon as possible. Hence, it is proposed that a referenced PDCCH candidate is defined as the candidate that starts earlier in time among the two linked PDCCH candidates in the time domain. For example, if the slot of the first PDCCH candidate that starts earlier in time is slot n, UE can suspend the SP-CSI transmission on the PUSCH after slot n.

(3) Reference slot of the second PDCCH candidate

For PDCCH repetition scheme, if the DCIs of the repeated PDCCHs are used to release the SP-CSI transmission on PUSCH, using the PDCCH candidate that ends later in time for suspending the SP-CSI transmission can provide more opportunities for the SP-CSI transmission. Hence, it is proposed that a referenced PDCCH candidate is defined as the candidate that ends later in time among the two linked PDCCH candidates in the time domain. For example, if the slot of the second PDCCH candidate that ends later in time is slot n, UE ignores the PDCCH candidate that starts earlier in time and suspends the SP-CSI transmission on the PUSCH after slot n.

2. Transmission occasion of SP-CSI reporting on PUSCH with repetition

For PUSCH repetition type B, the number of nominal repetitions is given by higher layer parameter numberOfRepetitions-r16. For the n-th nominal repetition, n=0, . . . , numberOfRepetitions-r16-1, the slot where the nominal repetition starts is given by

$${K}_{s} + ⌊ \frac{s + n \cdot L}{{N}_{symb}^{slot}} ⌋ ,$$

and the slot where the nominal repetition ends is given by

$${K}_{s} + ⌊ \frac{s + ( n + 1 ) \cdot L - 1}{{N}_{symb}^{slot}} ⌋ .$$

Here K is the slot where the PUSCH transmission starts, and N_{symb}^{slot} is the number of symbols per slot.

For a SP-CSI reporting on PUSCH without repetition, if Kₛ is the slot where the first SP-CSI report is transmitted on PUSCH, the m-th SP-CSI report is transmitted on slot (Kₛ+(m−1)*P), where P is the periodicity configured by the higher layer parameter reportSlotConfig.

From the above analysis, the transmission occasion of the n-th nominal repetition (e.g. type A and type B) may be different from the transmission occasion of the n-th SP-CSI report on PUSCH without repetition. Hence, in this section, a method is proposed to determine the transmission occasion of SP-CSI reporting on PUSCH with repetition.

To simplify the process of determining the SP-CSI reporting occasion on PUSCH with repetition, it is straightforward to report the SP-CSI on PUSCH with repetition based on the transmission occasion of PUSCH with repetition. It is proposed that when a UE receives a DCI that activates SP-CSI report(s) on PUSCH by a CSI request field on the DCI, the SP-CSI reporting occasion is determined by the occasion of PUSCH with repetition (e.g. type A and type B). In detail, the first SP-CSI reporting occasion on PUSCH with repetition (e.g. type A and type B) is the first transmission occasion of PUSCH with repetition (e.g. type A and type B); the second SP-CSI reporting occasion on PUSCH with repetition is the second transmission occasion of PUSCH with repetition (e.g. type A and type B). If the number of SP-CSI reporting occasion is more than two, the same mapping mechanism applies to the remaining SP-CSI reporting occasions.

3. A-CSI/SP-CSI reporting on PUSCH with repetition with UL data
3.1 A-CSI reporting on PUSCH with repetition with UL data

For PUSCH repetition type B, due to the crossing slot boundary or invalid symbols, a nominal repetition is divided into multiple actual repetitions. In this section, several methods are proposed to multiplex the A-CSI on different repetitions with different beams.

(1) The actual repetition on the next nominal repetition

Since the actual repetitions of the first nominal repetition with the second beam may not have the same number of symbols as the first actual repetition of the first nominal repetition with the first beam, the actual repetition on the next nominal repetition with the second beam can be taken into consideration so that A-CSI may have the same opportunity to be successfully multiplexed on these actual repetitions with different beams.

It is proposed that for PUSCH repetition type B, when a UE is scheduled to transmit a transport block and A-CSI report(s) on PUSCH by a CSI request field on a DCI, the A-CSI report(s) is multiplexed on the first actual repetition with the first beam and the first actual repetition with the second beam that has the same number of symbols as the first actual repetition with the first beam, where both the first actual repetitions have at least two symbols in time domain. In detail, if the first actual repetition with the second beam does not have the same number of symbols as the first actual repetition with the first beam, the remaining actual repetition with the second beam would be considered with the same principle. With this method, the same number of symbols may be allocated for two actual repetitions with different beams in the time domain resource allocation. Specially, if any actual repetition of the first nominal repetition corresponding to the second beam does not have the same number of symbols as the first actual repetition with the first beam, the actual repetition of the next nominal repetition corresponding to the second beam would be considered until the actual repetition corresponding to the second beam that has the same number of symbols as the first actual repetition with the first beam is found. In this case, the first nominal repetition with the second beam and the second nominal repetition with the first beam are omitted

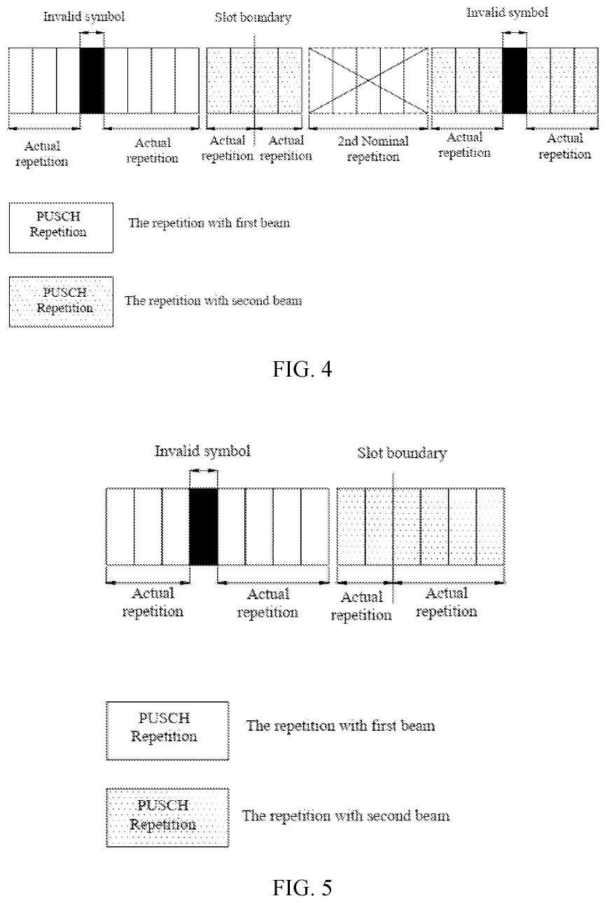

As is shown in FIG. 4, since any actual repetition of the first nominal repetition with the second beam does not has the same number of symbols as the first actual repetition with the first beam and the first actual repetition of the second nominal repetition with the second beam have the same number of symbols, A-CSI is multiplexed on the first actual repetition with the first beam and the first actual repetition of the second nominal repetition with the second beam.

(2) The actual repetition with a larger number of symbols

Since the actual repetitions of the first nominal repetition with the second beam may not have the same number of symbols as the first actual repetition of the first nominal repetition with the first beam, the actual repetition that corresponds to the second beam and has a larger number of symbols than the first actual repetition with the first beam can be taken into consideration. By this way, A-CSI may have more opportunity to be successfully multiplexed on these actual repetitions with different beams.

It is proposed that for PUSCH repetition type B, when a UE is scheduled to transmit a transport block and A-CSI report(s) on PUSCH by a CSI request field on a DCI, the A-CSI report(s) is multiplexed on the first actual repetition with the first beam and the first actual repetition with the second beam that has the same number of symbols as the first actual repetition with the first beam, where both the first actual repetitions have at least two symbols in time domain. In detail, if any actual repetition of the first nominal repetition with the second beam does not have the same number of symbols as the first actual repetition with the first beam and there is at least one actual repetition of the first nominal repetition with the second beam that has a larger number of symbols than the first actual repetition with the first beam, A-CSI report(s) is multiplexed on the first actual repetition with the first beam and the first actual repetition with the second beam that has a larger number of symbols than the first actual repetition with the first beam.

As is shown in FIG. 5, since any actual repetition of the first nominal repetition with the second beam does not has the same number of symbols as the first actual repetition with the first beam and the second actual repetition of the second nominal repetition with the second beam has a larger number of symbols, A-CSI is multiplexed on the first actual repetition with the first beam and the second actual repetition with the second beam.

3.2 SP-CSI reporting on PUSCH with repetition with UL data

To report the SP-CSI on PUSCH with repetition as soon as possible and improve the reliability of SP-CSI, it is proposed that SP-CSI report(s) can be multiplexed on the PUSCH with uplink data transmission and SP-CSI report(s) is multiplexed on multiple PUSCHs with different beams. In this section, several methods are proposed to multiplex SP-CSI on PUSCH with repetition type A and type B.

3.2.1 SP-CSI reporting on PUSCH with repetition type A

For PUSCH repetition type A, different repetitions of PUSCH are in different slots. Hence, it is straightforward to multiplex the SP-CSI on the first PUSCH repetitions corresponding to different beams. It is proposed that for PUSCH repetition type A, when a UE is scheduled to transmit a transport block and SP-CSI report(s) on PUSCH by a CSI request field on a DCI, the CSI report(s) is multiplexed on the first PUSCH repetition corresponding to the first beam and the first PUSCH repetition corresponding to the second beam, as is shown in the FIG. 6.

3.2.2 SP-CSI reporting on PUSCH with repetition type B
(1) The first actual repetition with the same number of symbols

Since a nominal repetition can be divided into multiple actual repetitions and different actual repetitions may have different number of symbols, if the first actual repetition corresponding to the first beam and the first actual repetition corresponding to the second beam have the same number of symbols, SP-CSI may have the same opportunity to be successfully multiplexed on these first actual repetitions.

It is proposed that for PUSCH repetition type B, when a UE is scheduled to transmit a transport block and SP-CSI report(s) on PUSCH by a CSI request field on a DCI, the CSI report(s) is multiplexed on the first actual repetition of the first nominal repetition corresponding to the first beam and the first actual repetition corresponding to the second beam that has the same number of symbols as the first actual repetition with first beam, where the number of symbols in time domain is at least two. In detail, if the first actual repetition of the first nominal repetition with the second beam does not have the same number of symbols as the first actual repetition with the first beam, the next actual repetition of the first nominal repetition with the second beam would be considered with the same principle. With this method, the same number of symbols may be allocated for two actual repetitions with different beams in the time domain resource allocation. Specially, if any actual repetition of the first nominal repetition corresponding to the second beam does not have the same number of symbols as the first actual repetition with the first beam, the actual repetition of the next nominal repetition corresponding to the second beam would be considered.

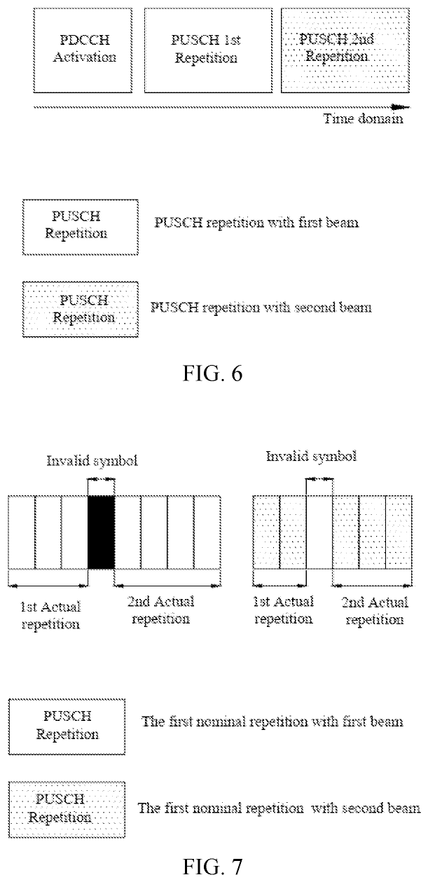

As is shown in FIG. 7, since the first actual repetition with the first beam and the second actual repetition with the second beam have the same number of symbols, SP-CSI is multiplexed on these two actual repetitions.

(2) The first nominal repetition is the same as the first actual repetition

Considering that different actual repetitions may occupy a small time duration, i.e. have a small number of symbols, and A-CSI may have a priority over SP-CSI to be multiplexed on PUSCH, if SP-CSI is transmitted on the actual repetition and the SP-CSI payload is not small, the SP-CSI may be dropped. Hence, it is preferable to multiplex the SP-CSI on the nominal repetition that is not segmented into multiple actual repetitions.

Considering that the SP-CSI would be transmitted on two nominal repetitions, it is proposed that for PUSCH repetition type B, when a UE is scheduled to transmit a transport block and SP-CSI report(s) on PUSCH by a CSI request field on a DCI, the CSI report(s) is multiplexed on the first nominal repetition corresponding to the first beam and the first nominal repetition corresponding to the second beam, where both the first nominal repetitions are expected to be the same as the corresponding first actual repetition, in other words, both the first nominal repetitions are not expected to be segmented into multiple actual repetitions. If the first nominal repetition corresponding to the first beam is not the same as the first actual repetition, this nominal repetition is omitted and the next nominal repetition corresponding to the first beam would be considered with the same principle. If the first nominal repetition corresponding to the second beam is not the same as the first actual repetition, this nominal repetition is omitted and the next nominal repetition corresponding to the second beam would be considered with the same principle.

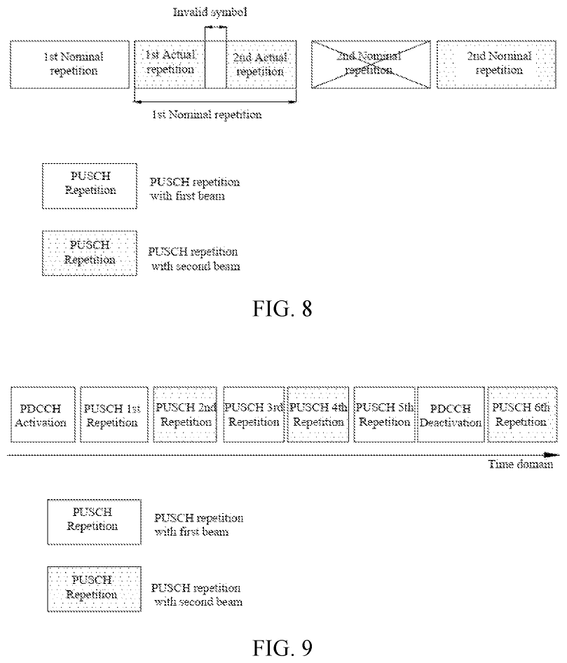

For the cases of cyclic mapping pattern, as is shown in FIG. 8, regarding the first beam, the SP-CSI is multiplexed on the first nominal repetition. Regarding the second beam, considering that the first nominal repetition corresponding to the second beam is segmented into two actual repetitions, the SP-CSI is multiplexed on the second nominal repetition.

4. A-CSI/SP-CSI reporting on PUSCH with repetition without UL data
4.1 A-CSI/SP-CSI reporting on PUSCH with repetition type A
(1) CSI transmitting on two PUSCH repetitions

For PUSCH repetition type A, different repetitions of PUSCH are in different slots. Hence, it is straightforward to transmit the CSI on the first PUSCH repetitions corresponding to different beams. It is proposed that for PUSCH repetition type A, when a UE receives a DCI that schedules A-CSI report(s) or activates SP-CSI report(s) on PUSCH without no transport block by a CSI request field on a DCI, the A-CSI/SP-CSI is transmitted on the first PUSCH repetition corresponding to the first beam and the first PUSCH repetition corresponding to the second beam.

(2) CSI transmitting on more than two PUSCH repetitions

If A-CSI/SP-CSI is transmitted on more than two PUSCH repetitions with different beams, the higher reliability of A-CSI/SP-CSI report(s) can be achieved. It is proposed that for PUSCH repetition type A, when a UE receives a DCI that schedules A-CSI report(s) or activates SP-CSI report(s) on PUSCH without no transport block by a CSI request field on a DCI, the A-CSI/SP-CSI is transmitted on the PUSCH repetitions corresponding to the first beam and the PUSCH repetitions corresponding to the second beam until UE completes all the PUSCH repetitions. In addition, for SP-CSI reporting, UE can suspend the SP-CSI reporting on PUSCH with repetition when UE successful decodes the DCI (e.g. DCI format 0_1 and DCI format 0_2) which contains a CSI request field indicating the SP-CSI trigger state to deactivate.

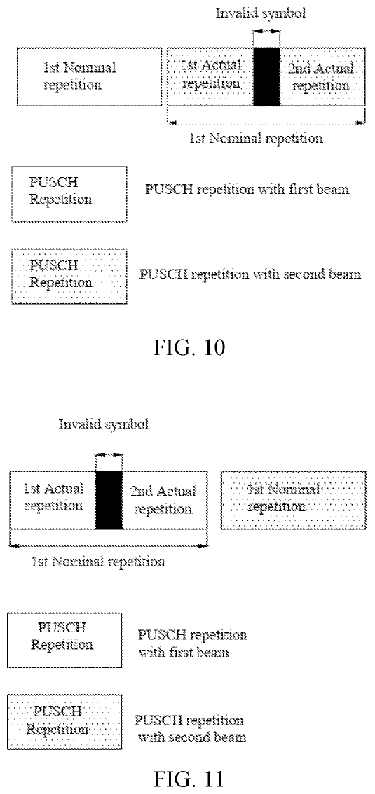

For the cases of cyclic mapping pattern, as is shown in the FIG. 9, if UE receives a PDCCH indicating the release of SP CSI transmission on PUSCH with repetitions, UE can suspend the SP-CSI transmission on the PUSCH after receiving the DCI. On the other hand, UE can suspend the A-CSI/SP-CSI transmission on the PUSCH with repetition when UE completes all the PUSCH repetitions, where the number of repetitions is determined by the higher layer parameter numberOfRepetitions-r16 and pusch-AggregationFactor.

4.2 A-CSI/SP-CSI reporting on PUSCH with repetition type B

For PUSCH repetition type B, due to the crossing slot boundary or invalid symbols, a nominal repetition is divided into multiple actual repetitions. Considering that different actual repetitions may occupy different time duration, i.e. have different numbers of symbols, and A-CSI may have a priority over SP-CSI to be multiplexed on PUSCH, there may be different methods to carry the A-CSI/SP-CSI on PUSCH with repetition type B. In this section, several methods are proposed to transmit the A-CSI/SP-CSI on PUSCH with repetition type B.

4.2.1 A-CSI/SP-CSI transmitting on two PUSCH repetitions

For PUSCH repetition type B, when a UE receives a DCI that schedules A-CSI report(s) or activates SP-CSI report(s) on PUSCH with no transport block by a CSI request field on a DCI, the number of nominal repetitions is always assumed to be two, regardless of the value of higher layer parameter numberOfRepetitions-r16.

(1) The first nominal repetition

Since a nominal repetition can be divided into multiple actual repetitions and there are several kinds of invalid symbol(s) for PUSCH repetition type B, if A-CSI/SP-CSI is transmitted on both the first nominal repetitions whether the first nominal repetition is segmented into multiple actual repetitions or not, the A-CSI/SP-CSI would be transmitted as soon as possible and simplify the process to report the A-CSI/SP-CSI on two repetitions with different beams.

It is proposed that for PUSCH repetition type B, when a UE receives a DCI that schedules A-CSI report(s) or activates SP-CSI report(s) on PUSCH without no transport block by a CSI request field on a DCI, the A-CSI/SP-CSI is transmitted on the first nominal repetition corresponding to the first beam and the first nominal repetition corresponding to the second beam. In detail, if any of both the first nominal repetitions is segmented into multiple actual repetitions, A-CSI/SP-CSI is transmitted on the first actual repetition of this first nominal repetition, where the first actual repetition has at least two symbols in time domain. If the first actual repetition of the first nominal repetition has a single symbol duration, the A-CSI/SP-CSI is transmitted on the next actual repetition of this first nominal repetition.

As is shown in the FIG. 10, since the first nominal repetition corresponding to the first beam is not divided into multiple actual repetitions and the first nominal repetition corresponding to the second beam is divided into two actual repetitions, the A-CSI/SP-CSI is transmitted in the first nominal repetition corresponding to the first beam and the first actual repetition of the first nominal repetition corresponding to the second beam.

As is shown in another FIG. 11, since the first nominal repetition corresponding to the first beam is divided into two actual repetitions, the A-CSI/SP-CSI is transmitted in the first actual repetition of the first nominal repetition corresponding to the first beam and the first nominal repetition corresponding to the second beam.

(2) The first actual repetition with the same number of symbols

Since a nominal repetition can be divided into multiple actual repetitions and different actual repetitions may have different number of symbols, if the first actual repetition corresponding to the first beam and the first actual repetition corresponding to the second beam have the same number of symbols, A-CSI/SP-CSI may have the same opportunity to be successfully multiplexed on these first actual repetitions with different beams.

It is proposed that for PUSCH repetition type B, when a UE receives a DCI that schedules A-CSI report(s) or activates SP-CSI report(s) on PUSCH without no transport block by a CSI request field on a DCI, the A-CSI/SP-CSI is transmitted on the first actual repetition of the first nominal repetition corresponding to the first beam and the first actual repetition corresponding to the second beam that has the same number of symbols as the first actual repetition with first beam, where the number of symbols in time domain is at least two. In detail, if the first actual repetition with the second beam does not have the same number of symbols as the first actual repetition with the first beam, the next actual repetition with the second beam would be considered with the same principle. With this method, the same number of symbols may be allocated for two actual repetitions with different beams in the time domain resource allocation. Specially, if any actual repetition of the first nominal repetition corresponding to the second beam does not have the same number of symbols as the first actual repetition with the first beam, the actual repetition of the next nominal repetition corresponding to the second beam would be considered.

As is shown in FIG. 7, since the first actual repetition with the first beam and the second actual repetition with the second beam have the same number of symbols, A-CSI/SP-CSI is transmitted on these two actual repetitions.

(3) The actual repetition with a larger number of symbols

Since the actual repetitions of the first nominal repetition with the second beam may not have the same number of symbols as the first actual repetition of the first nominal repetition with the first beam, the actual repetition that corresponds to the second beam and has a larger number of symbols than the first nominal repetition with the first beam can be taken into consideration. By this way, A-CSI/SP-CSI may have more opportunity to be successfully transmitted on these actual repetitions with different beams.

It is proposed that for PUSCH repetition type B, when a UE receives a DCI that schedules A-CSI report(s) or activates SP-CSI report(s) on PUSCH without no transport block by a CSI request field on a DCI, the A-CSI/SP-CSI is transmitted on the first actual repetition with the first beam and the first actual repetition with the second beam that has the same number of symbols as the first actual repetition with the first beam, where both the first actual repetitions have at least two symbols in time domain. In detail, if any actual repetition of the first nominal repetition with the second beam does not have the same number of symbols as the first actual repetition with the first beam and there is at least one actual repetition of the first nominal repetition with the second beam that has a larger number of symbols than the first actual repetition with the first beam, A-CSI/SP-CSI report(s) is multiplexed on the first actual repetition with the first beam and the first actual repetition with the second beam that has a larger number of symbols than the first actual repetition with the first beam.

As is shown in above FIG. 5, since any actual repetition of the first nominal repetition with the second beam does not has the same number of symbols as the first actual repetition with the first beam and the second actual repetition of the second nominal repetition with the second beam has a larger number of symbols, A-CSI/SP-CSI is transmitted on the first actual repetition with the first beam and the second actual repetition with the second beam.

(4) The first actual repetition without limitation

Considering that there may be no actual repetition pairs corresponding to two beams with the same number of symbols, A-CSI/SP-CSI reporting on both the first actual repetitions corresponding to different beams can simplify the process and transmit the A-CSI/SP-CSI as soon as possible. It is proposed that for PUSCH repetition type B, when a UE receives a DCI that schedules A-CSI report(s) or activates SP-CSI report(s) on PUSCH without no transport block by a CSI request field on a DCI, the A-CSI/SP-CSI is transmitted on the first actual repetition of the first nominal repetition corresponding to the first beam and the first actual repetition corresponding to the second beam, where both first actual repetitions have at least two symbols in time domain.

As is shown in above FIG. 5, A-CSI/SP-CSI is transmitted on the first actual repetition with the first beam and the first actual repetition with the second beam.

(5) The first nominal repetition is the same as the first actual repetition

Considering that different actual repetitions may occupy a small time duration, i.e. have a small number of symbols, and A-CSI may have a priority over SP-CSI to be multiplexed on PUSCH, if SP-CSI is transmitted on the actual repetition and the SP-CSI payload is not small, the SP-CSI may be dropped. Hence, it is preferable to transmit the A-CSI/SP-CSI on the nominal repetition that is not segmented into multiple actual repetitions.

Considering that the A-CSI/SP-CSI would be transmitted on two nominal repetitions, it is proposed that for PUSCH repetition type B, when a UE receives a DCI that schedules A-CSI report(s) or activates SP-CSI report(s) on PUSCH without no transport block by a CSI request field on a DCI, the A-CSI/SP-CSI is transmitted on the first nominal repetition corresponding to the first beam and the first nominal repetition corresponding to the second beam, where both the first nominal repetitions are expected to be the same as the corresponding first actual repetition, in other words, both the first nominal repetitions are not expected to be segmented into multiple actual repetitions. If the first nominal repetition corresponding to the first beam is not the same as the first actual repetition, this nominal repetition is omitted and the next nominal repetition corresponding to the first beam would be considered with the same principle. If the first nominal repetition corresponding to the second beam is not the same as the first actual repetition, this nominal repetition is omitted and the next nominal repetition corresponding to the second beam would be considered with the same principle.

Specially, to have the same time domain allocation, the first nominal repetition corresponding to the first beam and the first nominal repetition corresponding to the second beam can have the same number of symbols.

For the cases of cyclic mapping pattern, as is shown in FIG. 8, regarding the first beam, the A-CSI/SP-CSI is transmitted on the first nominal repetition. Regarding the second beam, considering that the first nominal repetition corresponding to the second beam is segmented into two actual repetitions, the A-CSI/SP-CSI is transmitted on the second nominal repetition.

4.2.2 SP-CSI transmitting on more than two PUSCH repetitions

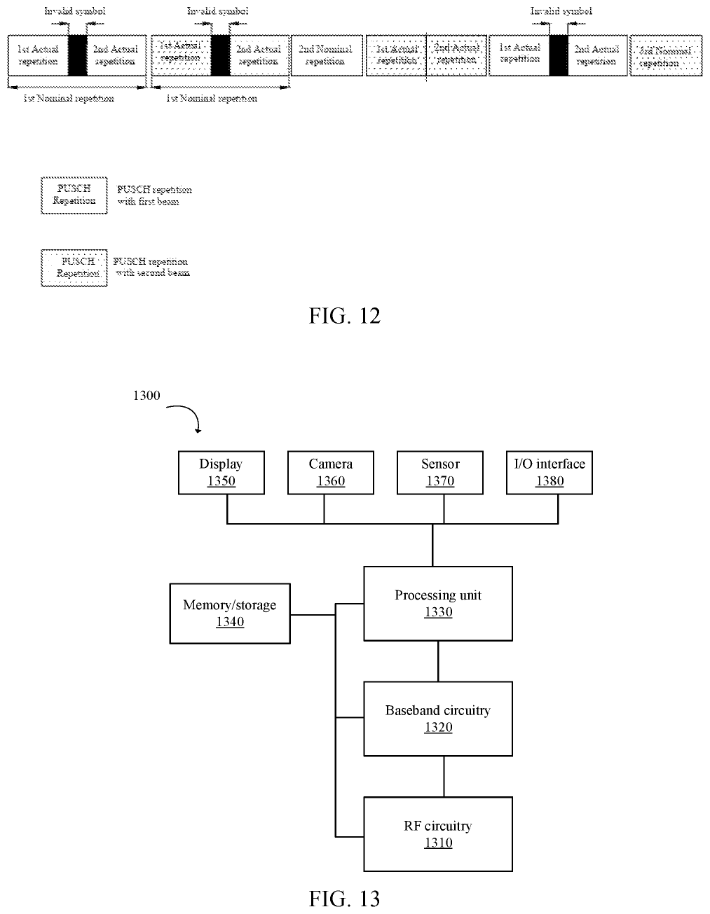

For the cases of cyclic mapping pattern, as is shown in the FIG. 12, if A-CSI/SP-CSI is transmitted on more than two PUSCH repetitions with different beams, the higher reliability of A-CSI/SP-CSI report(s) can be achieved.

(1) On every nominal repetition with different beams

To transmit A-CSI/SP-CSI as soon as possible and simplify the process to report the A-CSI/SP-CSI on more than two repetitions with different beams, it is proposed that for PUSCH repetition type B, when a UE receives a DCI that schedules A-CSI report(s) or activates SP-CSI report(s) on PUSCH without no transport block by a CSI request field on a DCI, the A-CSI/SP-CSI is transmitted on the nominal repetitions corresponding to the first beam and the nominal repetitions corresponding to the second beam until UE completes all the PUSCH repetitions, where the number of repetitions is determined by the higher layer parameter numberOfRepetitions-r16. For SP-CSI reporting on PUSCH with repetition type B, UE can suspend the SP-CSI reporting on PUSCH with repetition when UE successful decodes the DCI (e.g. DCI format 0_1 and DCI format 0_2) which contains a CSI request field indicating the SP-CSI trigger state to deactivate. In detail, if any of the nominal repetitions is not segmented into multiple actual repetitions, A-CSI/SP-CSI is transmitted on this nominal repetition, otherwise, A-CSI/SP-CSI is transmitted on the first actual repetition of this first nominal repetition, where the first actual repetition has at least two symbols in time domain. Moreover, if the first actual repetition of this nominal repetition has a single symbol duration, the A-CSI/SP-CSI is transmitted on the next actual repetition of this nominal repetition that has at least two symbols in time domain.

As is shown in the FIG. 12, regarding the first beam, the A-CSI/SP-CSI is transmitted on the first actual repetition of the first nominal repetition, the second nominal repetition and the first actual repetition of the third nominal repetition. Regarding the second beam, the A-CSI/SP-CSI is transmitted on the first actual repetition of the first nominal repetition, the first actual repetition of the second nominal repetition and the third nominal repetition.

(2) On the actual repetition with the same number of symbols

To provide the same opportunity to be successfully multiplexed on the actual repetitions, it is proposed that for PUSCH repetition type B, when a UE receives a DCI that schedules A-CSI report(s) or activates SP-CSI report(s) on PUSCH without no transport block by a CSI request field on a DCI, the A-CSI/SP-CSI is transmitted on the actual repetitions corresponding to the first beam and the actual repetitions corresponding to the second beam, where every actual repetition has at least two symbols in time domain and these actual repetitions corresponding to the two beams have the same number of symbols as the first actual repetition of the first nominal repetition with the first beam. In detail, for each nominal repetition corresponding to the first beam and second beam, A-CSI/SP-CSI is only transmitted on the first actual repetition that has the same number of symbols as the first actual repetition of the first nominal repetition corresponding to the first beam.

If UE receives a PDCCH indicating the release of SP CSI transmission on PUSCH with repetitions, UE can suspend the SP-CSI transmission on the PUSCH after receiving the DCI. On the other hand, UE can suspend the A-CSI/SP-CSI transmission on the PUSCH with repetitions when UE completes all the PUSCH repetitions, where the number of repetitions is determined by the higher layer parameter number0fRepetitions-r16.

As is shown in the FIG. 12, regarding the first beam, the first actual repetition of the third nominal repetition has the same number of symbols as the first actual repetition of the first nominal repetition. Regarding the second beam, both the first actual repetitions of the first nominal repetition and the second nominal repetition have the same number of symbols as the first actual repetition of the first nominal repetition corresponding to the first beam. The A-CSI/SP-CSI is transmitted on the first actual repetition of the first and third nominal repetition with the first beam, and the first actual repetition of the first and second nominal repetition with the second beam.

(3) The nominal repetition is the same as the first actual repetition

To avoid being dropped, it is proposed that for PUSCH repetition type B, when a UE receives a DCI that schedules A-CSI report(s) or activates SP-CSI report(s) on PUSCH without no transport block by a CSI request field on a DCI, the A-CSI/SP-CSI is transmitted on the nominal repetitions corresponding to the first beam and the nominal repetitions corresponding to the second beam, where every nominal repetition is the same as the first actual repetition of this nominal repetition, in other words, the nominal repetition is not divided into multiple actual repetitions.

If UE receives a PDCCH indicating the release of SP CSI transmission on PUSCH with repetitions, UE can suspend the SP-CSI transmission on the PUSCH after receiving the DCI. On the other hand, UE can suspend the A-CSI/SP-CSI transmission on the PUSCH with repetitions when UE completes all the PUSCH repetitions, where the number of repetitions is determined by the higher layer parameter numberOfRepetitions-r16.

As is shown in the FIG. 12, the second nominal repetition with the first beam and the third nominal repetition with the second beam are not segmented into multiple actual repetitions. Hence, the A-CSI/SP-CSI is transmitted on the second nominal repetition with the first beam and the third the second nominal repetition with the second beam.

FIG. 13 is a block diagram of an example system 1300 for wireless communication according to an embodiment of the present disclosure. Embodiments described herein may be implemented into the system using any suitably configured hardware and/or software. FIG. 13 illustrates the system 1300 including a radio frequency (RF) circuitry 1310, a baseband circuitry 1320, a processing unit 1330, a memory/storage 1340, a display 1350, a camera 1360, a sensor 1370, and an input/output (I/O) interface 1380, coupled with each other as illustrated.

The processing unit 1330 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 1320 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 1320 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 1310 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 1310 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, gNB or TRP may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 1340 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 1380 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 1370 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 1350 may include a display, such as a liquid crystal display and a touch screen display. In various embodiments, the system 1300 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1-11. (canceled)

12. A transmitter, configured to communicate in a communication system, the transmitter comprising:
one or more interfaces configured to communicate with multiple transmission-reception points (multi-TRPs) within the communication system; and
a circuitry configured to:
in response to transmit A-CSI/SP-CSI report without any transport block on two PUSCH repetitions and on PUSCH repetition type B, transmit the A-CSI/SP-CSI report on a first nominal repetition corresponding to a first beam and a first nominal repetition corresponding to a second beam,
wherein the number of nominal repetitions is always assumed to be two, regardless of the value of higher layer parameter numberOfRepetitions-r16.

13. The transmitter according to claim 12, wherein in the case that the A-CSI/SP-CSI report is transmitted on a first nominal repetition corresponding to a first beam and a first nominal repetition corresponding to a second beam, if any of both the first nominal repetitions corresponding to the first beam and the second beam is segmented into multiple actual repetitions, the A-CSI/SP-CSI report is transmitted on a first actual repetition of the first nominal repetition.

14. (canceled)

15. (canceled)

16. The transmitter according to claim 12, wherein in the case that the A CSI/SP CSI report is transmitted on a first nominal repetition corresponding to a first beam and a first nominal repetition corresponding to a second beam, if the first nominal repetition corresponding to the first beam is expected to be the same as the corresponding first actual repetition, and the first nominal repetition corresponding to the second beam is expected to be the same as the corresponding first actual repetition.

17. The transmitter according to claim 12, wherein the circuitry is configured to:
in response to transmit A-CSI/SP-C SI report without any transport block on more than two PUSCH repetitions and on PUSCH repetition type B, transmit the A-CSI/SP-CSI report on the nominal repetitions corresponding to the first beam and the nominal repetitions corresponding to the second beam until all the PUSCH repetitions are completed.

18. The transmitter according to claim 12, wherein the circuitry is configured to:
in response to transmit A-CSI/SP-C SI report without any transport block on more than two PUSCH repetitions and on PUSCH repetition type B, transmit the A-CSI/SP-CSI report on the actual repetitions corresponding to the first beam and the actual repetitions corresponding to the second beam, wherein every actual repetition has at least two symbols in time domain and these actual repetitions corresponding to the two beams have the same number of symbols as the first actual repetition of the first nominal repetition with the first beam.

19. The transmitter according to claim 12, wherein the circuitry is configured to:
in response to transmit A-CSI/SP-C SI report without any transport block on more than two PUSCH repetitions and on PUSCH repetition type B, transmit the A-CSI/SP-CSI report on the nominal repetitions corresponding to the first beam and the nominal repetitions corresponding to the second beam, wherein every nominal repetition is the same as the first actual repetition of this nominal repetition, and the nominal repetition is not divided into multiple actual repetitions.

20. The transmitter according to claim 12, wherein the circuitry is configured to:
in response to transmit A-CSI/SP-CSI report without any transport block on PUSCH repetition type A, transmit the A-CSI/SP-CSI report on a first PUSCH repetition corresponding to the first beam and a first PUSCH repetition corresponding to the second beam.
